(19) United States
(12) Patent Application Publication
(10) Pub. No.: US 2014/0111435 A1
(43) Pub. Date: Apr. 24, 2014

(54) CURSOR CONTROL DEVICE AND METHOD USING THE SAME TO LAUNCH A SWIPE MENU OF AN OPERATING SYSTEM

(71) Applicant: ELAN MICROELECTRONICS CORPORATION, Hsin Chu (TW)

(72) Inventors: Chia-Hsiang CHUANG, Zhudong Township (TW); Pei-Kang CHUNG, Zhubei City (TW); Ta-Huang LIU, Hsinchu City (TW); Chin-Nan WU, Zhubei City (TW)

(73) Assignee: ELAN MICROELECTRONICS CORPORATION, Hsin Chu (TW)

(21) Appl. No.: 13/758,186

(22) Filed: Feb. 4, 2013

(30) Foreign Application Priority Data
Oct. 22, 2012 (TW) 101139008

(51) Int. Cl. G06F 3/038

(52) U.S. Cl. CPC G06F 3/038
USPC 345/163

(57) ABSTRACT

A cursor control device has a touch control module for users to perform a swipe gesture. The touch control module generates a control command according to the swipe gesture and transmits the control command to a host computer. The host computer then launches a swipe menu on an edge of a display screen thereof Accordingly, after a host computer with the Win8™ installed therein as the operating system receives the control command, the edge swipe function supported by the Win8™ can be launched.

### BACKGROUND OF THE INVENTION

1. Field of the Invention

The present invention relates to a mouse and more particularly to a cursor control device and a method using the same to identify a swipe gesture.

2. Description of the Related Art

Microsoft has recently launched the latest operating system Win8™, which can support the swipe gesture around the edge of a touch panel. With reference to FIGS. 10A and 10B, if a touch panel 50 detects that a user's finger swipes in through an edge of the touch panel 50 and the swipe gesture complies with the requirement of swipe gesture defined in Win8™, Win8™ will display a swipe menu 51 (normally hidden and not displayed on the screen) alongside the edge for users of the touch panel 50 to operate the touch panel 50 in a more convenient fashion.

To use fingers to conveniently operate a Win8™-based touch panel, users must stand at a position in front of the touch panel with the touch panel reachable by users' fingers. If the touch panel is out of reach during operation, an additional input device, such as a mouse, must be incorporated for operation at a farther distance. However, as conventional mice do not support the swipe gestures defined in Win8™, host computers using the conventional mice should be improved in this regard.

### SUMMARY OF THE INVENTION

In view of the foregoing drawbacks, an objective of the present invention is to provide a cursor control device and a method using the same to launch a swipe menu of an operating system.

To achieve the foregoing objective, the cursor control device has a body and a touch control module.

The body has a host transmission interface and a cursor control module. The cursor control module is electrically connected to the host transmission interface.

The touch control module is electrically connected to the host transmission interface for operation of a finger gesture, generates a control command after the finger gesture is identified as a swipe gesture, and is adapted to output the control command to a host computer for a swipe menu to be displayed on an edge of a display screen of the host computer.

Preferably, the cursor control device also has a body, a cursor control module and a touch control module.

The body has at least one touch area adapted for users to perform a finger gesture.

The cursor control module is mounted inside the body.

The touch control module has a detection unit and a control unit. The detection unit has at least one sensing board mounted on the body and corresponding to the at least one touch area, detects the finger gesture, and outputs position data of the finger gesture.

The control unit is electrically connected to the detection unit to receive the position data of the finger gesture from the detection unit to identify the finger gesture as a swipe gesture and output a control command to an operating system to launch a swipe menu according to the identified swipe gesture.

To achieve the foregoing objective, the method using a cursor control device to launch a swipe menu of an operating system has steps of:

detecting position data of a finger gesture on the cursor control device through a detection unit;

identifying the finger gesture as a swipe gesture according to the position data of the finger gesture; and

generating and outputting a corresponding control command to an operating system according to the swipe gesture for the operating system to display a corresponding swipe menu.

The present invention is characterized by a touch control module mounted inside the body of the cursor control device for the body to possess a touch control function, in particular a function of identifying swipe gesture. A swipe control command accepted by the Win8™ can be outputted through the host transmission interface of the body so that a host computer having the Win8™ as its operating system can receive the swipe control command and launch the edge swipe function supported by the Win8™, namely, a swipe menu displayed on the screen in an identical moving direction as that of a swipe gesture, thereby achieving the same swipe function as a touch panel does. Accordingly, users of regular desktop computers can also enjoy the edge swipe function supported by the Win8™. Moreover, as the cursor and touch control functions in the present invention can be independently controlled, in comparison with conventional touch panels having both functions of cursor control and swipe gesture identification, the present invention less likely commits the errors in identifying swipe gestures.

Other objectives, advantages and novel features of the invention will become more apparent from the following detailed description when taken in conjunction with the accompanying drawings.

### BRIEF DESCRIPTION OF THE DRAWINGS

FIG. 1A is a schematic top view of an embodiment of a mouse in accordance with the present invention;

FIG. 1B is a schematic top view of another embodiment of a mouse in accordance with the present invention;

FIG. 2 is a cross-sectional side view of the mouse in FIG. 1A;

FIG. 3 is a schematic signal transition diagram illustrating a swipe control command outputted from a mouse and then transmitted to an operating system;

FIG. 4 is a flow diagram of a first method generating a swipe control command;

FIGS. 5A and 5B are schematic diagrams illustrating operation in FIG. 4;

FIG. 6 is a flow diagram of a second method generating a swipe control command;

FIGS. 7A and 7B are schematic diagrams illustrating operation in FIG. 6;

FIG. 8 is a flow diagram of a third method generating a swipe control command;

FIGS. 9A and 9B are schematic diagrams illustrating operation in FIG. 8; and

FIGS. 10A and 10B are schematic diagrams illustrating operation on a Win8™-based touch panel.

### DETAILED DESCRIPTION OF THE INVENTION

A cursor control device in accordance with the present invention is applicable to regular mice or other optical finger navigation (OFN) devices.

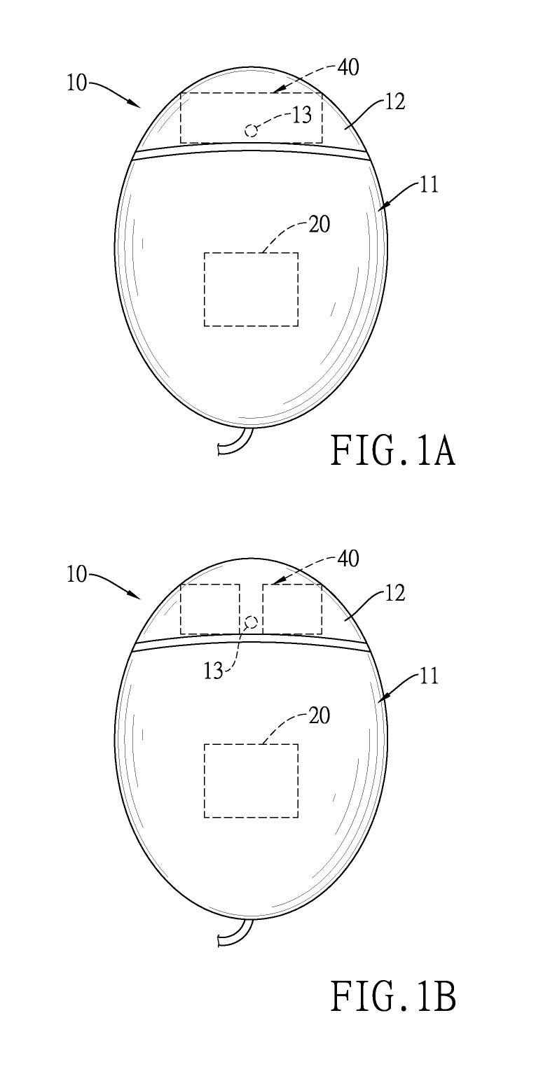

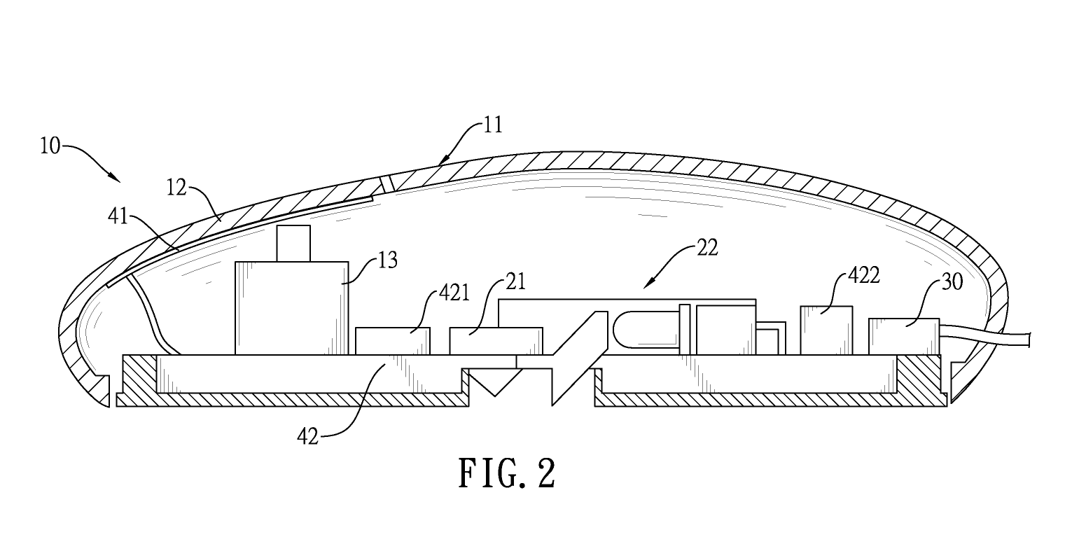

With reference to FIGS. 1A and 2, an embodiment of a cursor control device in accordance with the present invention is applicable to regular mice and has a body 10 and a touch control module 40.

The body at least has a host transmission interface 30 and a cursor control module 20. The host transmission interface 30 may be a USB connector, a PS2 connector and the like, or a wireless transmitter, such as a bluetooth module. The cursor control module 20 is electrically connected to the host transmission interface 30 and has a displacement sensor 22 and a cursor controller 21. The displacement sensor 22 may be an optical sensor, a laser sensor or a blue color light sensor. The cursor controller 21 is electrically connected to the displacement sensor 22 and the host transmission interface 30, and serves to control the movement of a cursor on the display screen of the host computer.

The touch control module 40 is electrically connected to the host transmission interface 30 for users to perform a swipe gesture, generates a control command according to the swipe gesture, and outputs the control command to a host computer, so that a swipe menu is displayed on an edge of a display screen of the host computer.

The body 10 further has a housing 11, a top cover 12 and at least one physical switching element 13.

The top cover 12 covers the housing 11 and has at least one touch area for the touch control module 40 to be mounted on the at least one touch area. When a user uses a finger to touch the at least one touch area of the top cover 12, the touch control module 40 then detects position data of the finger. In the present embodiment, the top cover 12 has one touch area.

The at least one physical switching element 13 is mounted inside the housing 11, is aligned with the touch control module 40, and is mounted below the touch control module 40. When the top cover 12 is touched and pressed down by a user's finger, the touch control module 40 is moved downwards to abut against and activate the physical switching element 13. In the present embodiment, one physical switching element 13 is mounted inside the housing 11.

The touch control module 40 has a detection unit 41 and a control unit 42. The detection unit 41 is affixed on an inner top of the top cover 12 and has at least one sensing board. To adapt to a non-planar top cover, each one of the at least one sensing board may be a flexible sensing board. In the present embodiment, the detection unit 41 has one sensing board. With reference to FIG. 1B, another embodiment of a cursor control device in accordance with the present invention is applicable to a mouse having a top cover 12 with two touch areas, and the detection unit 41 has two sensing boards. The two sensing boards are affixed on the inner top of the top cover 12 and respectively correspond to the two touch areas symmetrically located on the left and on the right.

The control unit 42 is fixed inside the housing 11 to receive the position data of the touch object sent from the detection unit 41 to identify a swipe gesture and output a control command. The control unit 42 has a touch controller 421 and a main controller 422. The touch controller 421 is electrically connected to the detection unit 41. The main controller 422 is electrically connected to the touch controller 421, the cursor controller 21 and the host transmission interface 30. The touch controller 421 serves to identify a swipe gesture. After the swipe gesture is identified, the main controller 422 generates a control command in compliance with corresponding USB or PS2 communication specifications and then outputs the control command to the host transmission interface 30. Furthermore, the cursor controller 21, the touch controller 421 and the main controller 422 can be commonly integrated in the control unit 42.

If determining that a touch object falls on a right side of the detection unit 41 upon detecting that the physical switching element 13 is pressed, the touch controller 421 generates a right button control signal, which is outputted through the host transmission interface 30. On the other hand, if determining that a touch object falls on a left side of the detection unit 41, the touch controller 421 generates a left button control signal. Hence, the original left and right button control function of the cursor control device 10 can be remained.

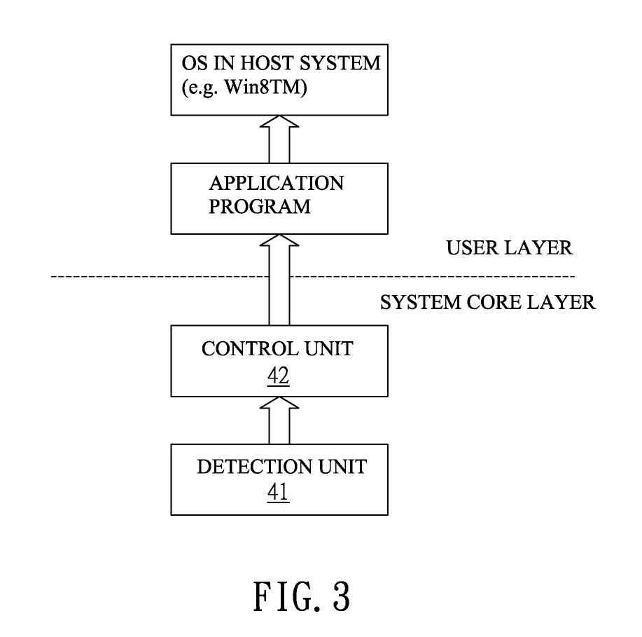

As Win8™ also supports the feature of setting up the edge swipe function with hot keys, with reference to FIG. 3, the touch controller 421 of the control unit 42 identifies a swipe gesture at a kernel layer of a mouse, the main controller 422 sends out a control command and further notifies an application program at a higher-level user layer of a host computer, the application program transmits a hot key signal corresponding to the swipe gesture to the Win8™, which is also at the same user layer, and the host computer executes a function corresponding to the hot key signal after receiving the hot key signal from the mouse. For example, when users perform a swipe gesture from left to right through a left boundary of a touch panel, once the swipe gesture is successfully identified, it will trigger the host computer to display a swipe menu alongside the left boundary of a display screen of the host computer.

As a summary, the cursor control device of the present invention can truly launch a swipe menu of the Win8™. It is the detection unit 41 that detects the position data of a touch object on the cursor control device, further identifies a corresponding swipe gesture generated according to the position data of the touch object, and finally outputs a control command according to the swipe gesture to the operating system for the operating system to display a corresponding swipe menu. The details as to how to identify a swipe gesture and generate a control command, that is, the methods of the foregoing touch control module 40 reacting to a direction in which a swipe gesture of a user's finger swipes and generating a control command, are further described as follows.

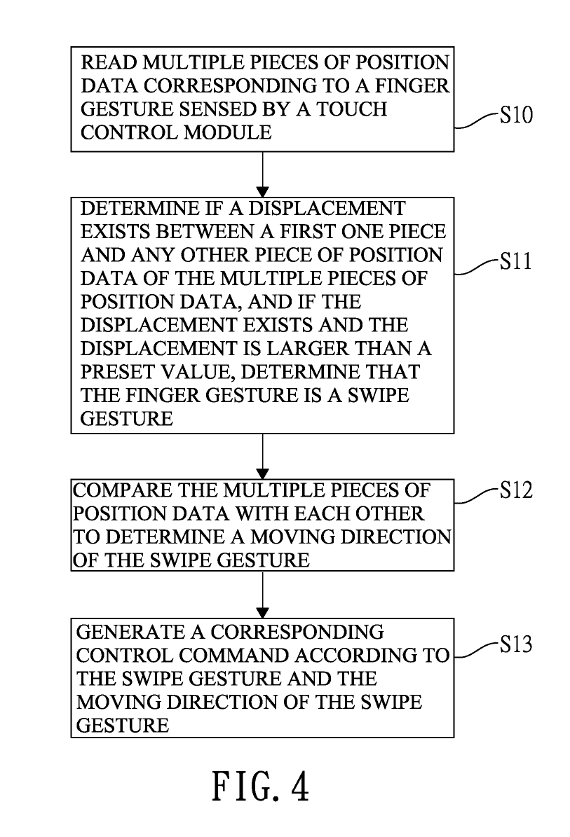

With reference to FIG. 4, a first method generating a swipe control command has the following steps.

Step S10: Read multiple pieces of position data corresponding to a finger gesture sensed by a touch control module.

Step S11: Determine if a displacement exists between a first one piece and any other piece of position data of the multiple pieces of position data, and if the displacement exists (including a horizontal displacement and/or a vertical displacement) and the displacement is larger than a preset value, determine that the finger gesture is a swipe gesture.

Step S12: Compare the multiple pieces of position data with each other to determine a moving direction of the swipe gesture.

Step S13: Generate a corresponding control command according to the swipe gesture and the moving direction of the swipe gesture.

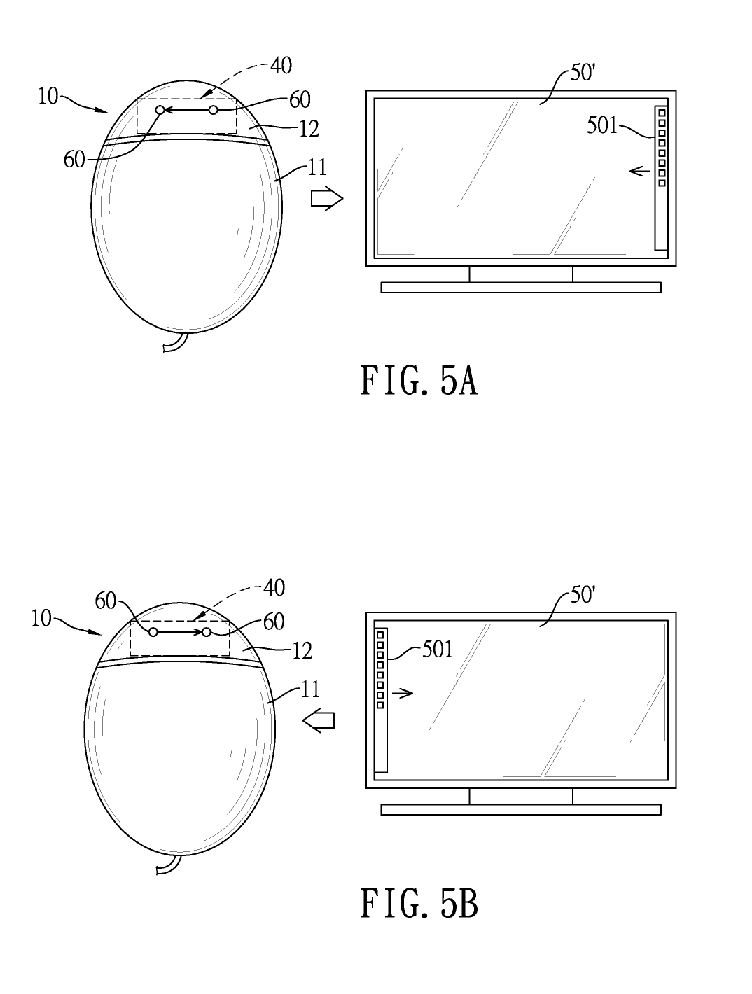

With reference to FIGS. 5A and 5B, when the aforementioned method of generating a swipe control command is executed, the touch control module 40 detects if a single finger or two fingers swipe on the sensing board thereof Once the swiping displacement exceeds the preset value, a swipe control command corresponding to a right, left, top or bottom boundary of a display is generated to trigger a hot key signal for launching a right, left, top or bottom swipe menu of the Win8™ on the display screen 50′. After receiving the swipe control command outputted from the cursor control device, the host computer generates a corresponding hot key signal and displays a hidden swipe menu 501 on the screen according to the moving direction of the swipe gesture.

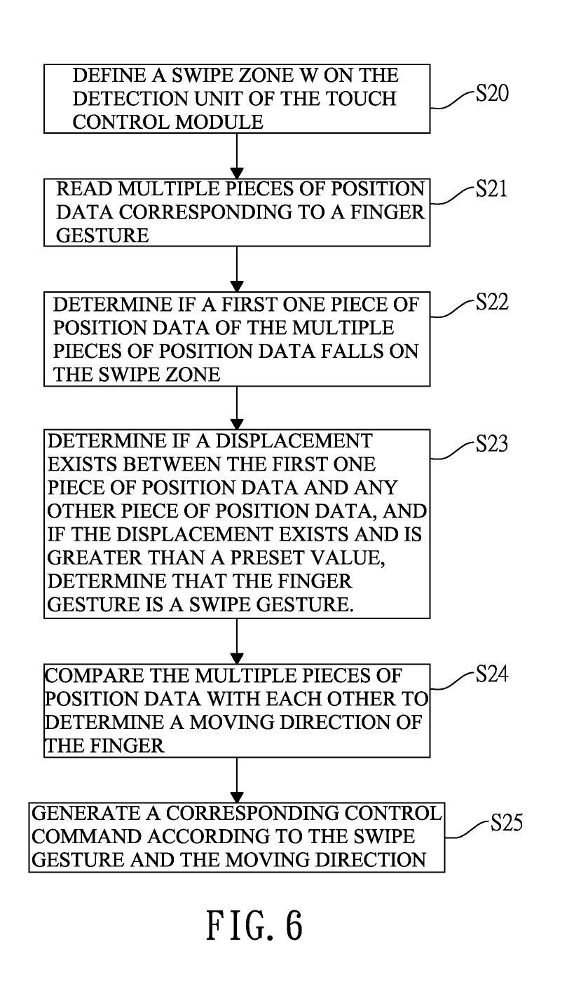

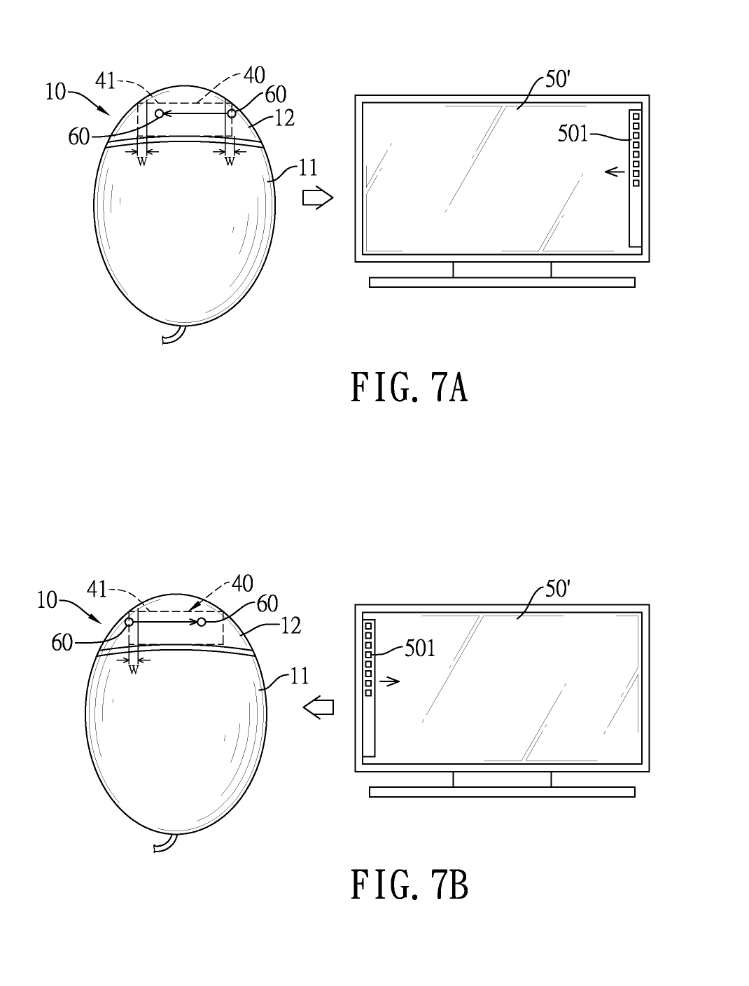

With reference to FIGS. 6 and 7A, a second method of generating a swipe control command has the following steps.

Step S20: Define a swipe zone W on the detection unit 41 of the touch control module 40.

Step S21: Read multiple pieces of position data corresponding to a finger gesture.

Step S22: Determine if a first one piece of position data of the multiple pieces of position data falls on the swipe zone W.

Step S23: If positive, further determine if a displacement exists between the first one piece of position data and any other piece of position data, and if the displacement exists and is greater than a preset value, determine that the finger gesture is a swipe gesture.

Step S24: Compare the multiple pieces of position data with each other to determine a moving direction of the finger.

Step S25: Generate a corresponding control command according to the swipe gesture and the moving direction.

With reference to FIGS. 7A and 7B, when the aforementioned method of generating a swipe control command is executed, a swipe gesture is identified only when the finger gesture with one finger or two fingers touches the swipe zone W of the detection unit 41 and the finger gesture moves beyond a preset distance. A swipe control command corresponding to a right, left, top or bottom boundary of a display is generated according to the swipe gesture and the moving direction to trigger a hot key signal for launching a swipe menu of the Win8™ on the right, left, top or bottom boundary of the display screen 50′. After receiving the swipe control command outputted from the cursor control device, the host computer generates a corresponding hot key signal and displays a hidden swipe menu 501 on the screen according to the moving direction of the swipe gesture.

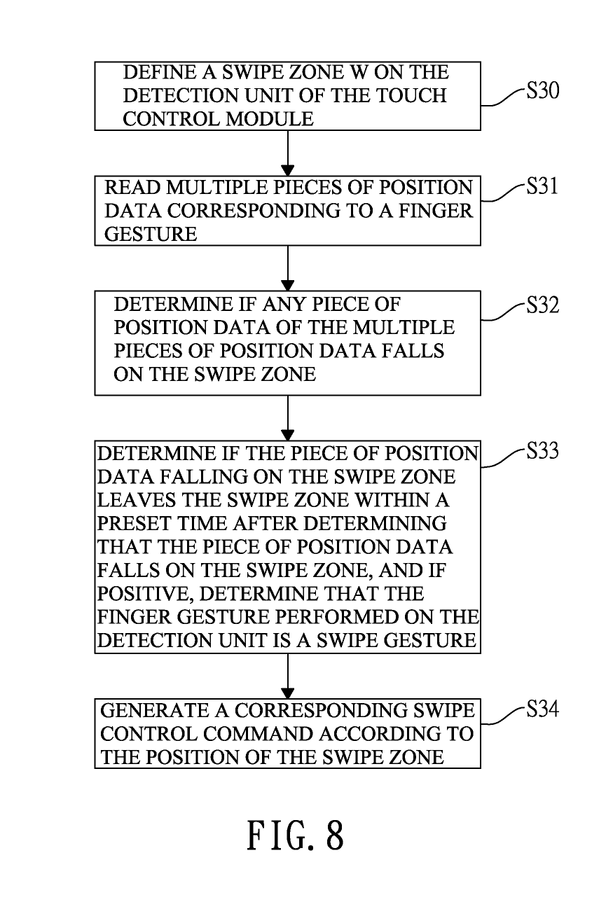

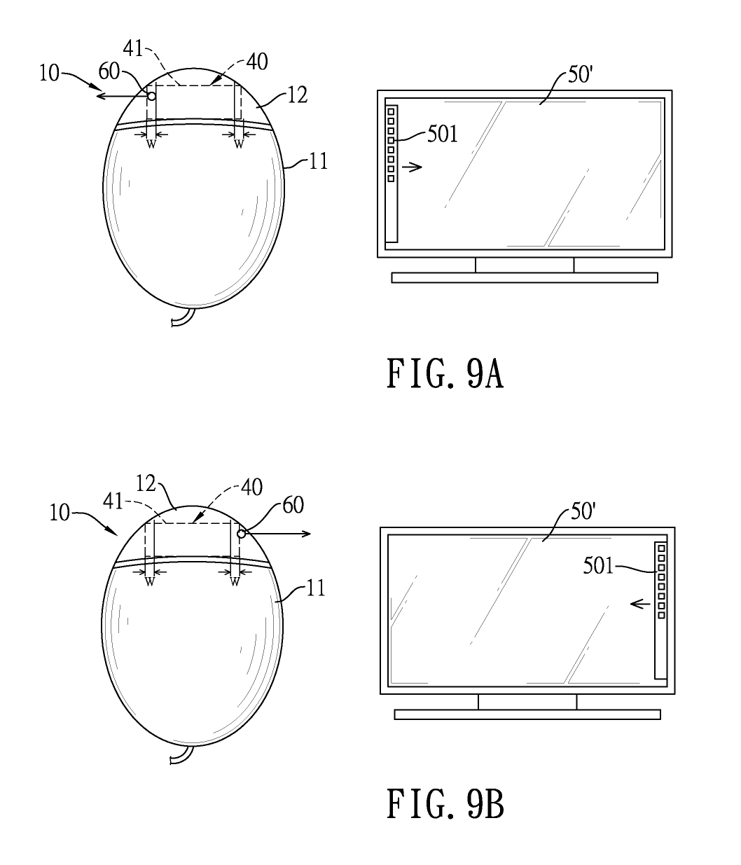

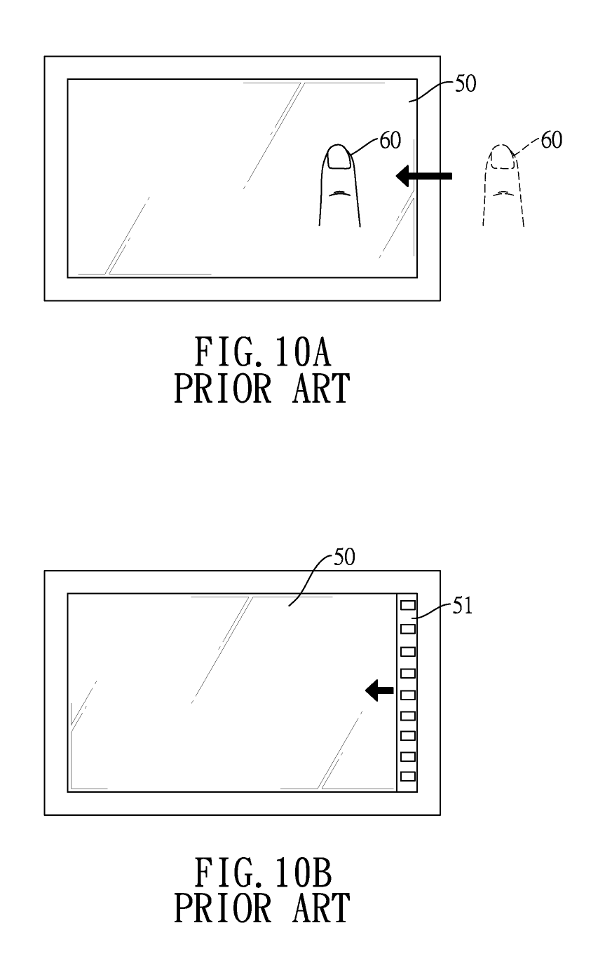

With reference to FIGS. 8 and 9A, a third method of generating a swipe control command has the following steps.

Step S30: Define a swipe zone W on the detection unit 41 of the touch control module 40.

Step S31: Read multiple pieces of position data corresponding to a finger gesture.

Step S32: Determine if any piece of position data of the multiple pieces of position data falls on the swipe zone W.

Step S33: Determine if the piece of position data falling on the swipe zone is absent from the swipe zone within a preset time after determining that the piece of position data falls on the swipe zone, and if positive, determine that the finger gesture performed on the detection unit 41 is a swipe gesture. Given a scan cycle 12 ms of the touch control module 40 as an example, the preset time can be configured as 250 ms.

Step S34: Generate a corresponding swipe control command according to the position of the swipe zone.

When the aforementioned method of generating a swipe control command is executed, the detection unit 41 can launch a swipe menu corresponding to a touched position by using one finger or two fingers touching a swipe zone to swipe outwards away from the detection unit 41 as shown in FIGS. 9A and 9B or by clicking on an edge of the detection unit 41. The present invention can generate a swipe control command corresponding to a right, left, top or bottom boundary of a display. For example, when users touch a right swipe zone W on the detection unit 41, the Win8™ will display a swipe menu on a right edge of the display screen; when users touch a left swipe zone W on the detection unit 41, the Win8™ will display a swipe menu on a left edge of the display screen.

As the detection unit 41 is mounted on the inner top of the top cover 12, users cannot be sure where the edge of the detection unit 41 is during the actual operation of the detection unit 41. It is likely that a swipe gesture is unable to be successively completed and the operational smoothness is affected. In this regard, the methods of generating a swipe control command in FIGS. 6 and 8 can be jointly applied. In other words, as long as users' gestures meet the condition for identifying a gesture disclosed in FIG. 6 or 8, the gestures can be identified as swipe gestures, thereby enhancing the overall operational smoothness.

In sum, the cursor control device of the present invention can identify a swipe gesture according to a swipe movement of a user and generate a corresponding swipe control command based on a direction in which the swipe gesture swipes. After the cursor control device generates the swipe control command and outputs the swipe control command through the existing host transmission interface of the cursor control device to a host computer, the Win8™ then launches the edge swipe function, that is, a swipe menu displayed on an edge of the display screen, to fulfill the same control function as a touch panel does. Accordingly, users can launch the edge swipe function of the Win8™ through the cursor control device without directly touching the display screen of a touch panel.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A cursor control device for identifying a swipe gesture comprising:
a body having:
a host transmission interface; and
a cursor control module electrically connected to the host transmission interface; and
a touch control module electrically connected to the host transmission interface for operation of a finger gesture, generating a control command after the finger gesture is identified as a swipe gesture, and adapted to output the control command to a host computer for a swipe menu to be displayed on an edge of a display screen of the host computer.

2. The cursor control device as claimed in claim 1, wherein the touch control module determines a finger gesture as a swipe gesture by steps of:
reading multiple pieces of position data corresponding to the finger gesture; and
determining if a displacement exists between a first one piece and any other piece of position data of the multiple pieces of position data, and if the displacement exists and the displacement is larger than a preset value, determining that the finger gesture is a swipe gesture.

3. The cursor control device as claimed in claim 1, wherein the touch control module determines the finger gesture as a swipe gesture by steps of:
defining a swipe zone on the touch control module;
reading multiple pieces of position data corresponding to the finger gesture;
determining if a first one piece of position data of the multiple pieces of position data falls on the swipe zone; and
if positive, further determining if a displacement exists between the first one piece of position data and any other piece of position data, and if the displacement exists and is greater than a preset value, determining that the finger gesture is a swipe gesture.

4. The cursor control device as claimed in claim 2, wherein the touch control module generates the control command by steps of:
comparing the multiple pieces of position data with each other to determine a moving direction of the swipe gesture; and
generating a corresponding control command according to the swipe gesture and the moving direction of the swipe gesture.

5. The cursor control device as claimed in claim 3, wherein the touch control module generates the control command by steps of:
comparing the multiple pieces of position data with each other to determine a moving direction of the swipe gesture; and
generating a corresponding control command according to the swipe gesture and the moving direction of the swipe gesture.

6. The cursor control device as claimed in claim 1, wherein the touch control module generates the control command by steps of:
defining a swipe zone on the touch control module;
reading multiple pieces of position data corresponding to the finger gesture;
determining if any piece of position data falls on the swipe zone and if the piece of position data falling on the swipe zone is absent from the swipe zone within a preset time after determining that the piece of position data falls on the swipe zone, and if positive, determining that the finger gesture is a swipe gesture; and
generating a corresponding control command according to the piece of position data falling on the swipe zone.

7. The cursor control device as claimed in claim 1, wherein the control command has:
a right-edge swipe control command for displaying a swipe menu on a right edge of the display screen of the host computer;
a left-edge swipe control command for displaying a swipe menu on a left edge of the display screen of the host computer;
a top-edge swipe control command for displaying a swipe menu on a top edge of the display screen of the host computer; and
a bottom-edge swipe control command for displaying a swipe menu on a bottom edge of the display screen of the host computer.

8. The cursor control device as claimed in claim 1, wherein the body has:
a housing;
a top cover covering the housing and having at least one touch area for the touch control module to be mounted on the at least one touch area; and
at least one physical switching element mounted inside the housing, and aligned with the touch control module.

9. The cursor control device as claimed in claim 8, wherein the touch control module has:
a detection unit having at least one sensing board mounted on an inner top of the top cover and corresponding to the at least one touch area, detecting the finger gesture, and outputting position data of the finger gesture; and
a control unit electrically connected to the detection unit to receive the position data of the finger gesture from the detection unit to identify the finger gesture as a swipe gesture and output the control command.

10. The cursor control device as claimed in claim 9, wherein the control unit has:
a touch controller electrically connected to the detection unit; and
a main controller electrically connected to the touch controller, generating the control command, and outputting the control command to the host transmission interface after the swipe gesture is identified by the touch controller.

11. The cursor control device as claimed in claim 10, wherein the cursor control module has a cursor controller for controlling movement of a cursor on the display screen of the host computer, and the cursor controller, the touch controller and the main controller are commonly integrated in the control unit.

12. A cursor control device identifying a swipe gesture comprising:
a body having at least one touch area adapted for users to perform a finger gesture;
a cursor control module mounted inside the body; and
a touch control module having:
a detection unit mounted on the body and corresponding to the at least one touch area, detecting the finger gesture, and outputting position data of the finger gesture; and
a control unit electrically connected to the detection unit to receive the position data of the finger gesture from the detection unit to identify the finger gesture as a swipe gesture and output a control command to an operating system to launch a swipe menu according to the identified swipe gesture.

13. The cursor control device as claimed in claim 12, wherein the touch control module identifies the swipe gesture by steps of:
reading multiple pieces of position data corresponding to the finger gesture; and
determining if a displacement exists between a first one piece and any other piece of position data of the multiple pieces of position data, and if the displacement exists and the displacement is larger than a preset value, determining that the finger gesture is a swipe gesture.

14. The cursor control device as claimed in claim 12, wherein the touch control module identifies the swipe gesture by steps of:
defining a swipe zone on the touch control module;
reading multiple pieces of position data corresponding to the finger gesture;
determining if a first one piece of position data of the multiple pieces of position data falls on the swipe zone; and
if positive, further determining if a displacement exists between the first one piece of position data and any other piece of position data, and if the displacement exists and is greater than a preset value, determining that the finger gesture is a swipe gesture.

15. The cursor control device as claimed in claim 13, wherein the touch control module transmits the control command by steps of:
comparing the multiple pieces of position data with each other to determine a moving direction of the swipe gesture; and
generating a corresponding control command according to the swipe gesture and the moving direction of the swipe gesture.

16. The cursor control device as claimed in claim 14, wherein the touch control module transmits the control command by steps of:
comparing the multiple pieces of position data with each other to determine a moving direction of the swipe gesture; and
generating a corresponding control command according to the swipe gesture and the moving direction of the swipe gesture.

17. The cursor control device as claimed in claim 12, wherein the touch control module transmits the control command by steps of:
defining a swipe zone on the touch control module;
reading multiple pieces of position data corresponding to the finger gesture;
determining if any piece of position data falls on the swipe zone and if the piece of position data falling on the swipe zone is absent from the swipe zone after determining that the piece of position data falls on the swipe zone, and if positive, determining that the finger gesture is a swipe gesture; and
generating a corresponding control command according to the piece of position data falling on the swipe zone.

18. The cursor control device as claimed in claim 12, wherein the control command generated by the touch control module has:
a right-edge swipe control command for controlling the operating system to display a swipe menu on a right edge of a display screen of a host computer;
a left-edge swipe control command for controlling the operating system to display a swipe menu on a left edge of a display screen of a host computer;
a top-edge swipe control command for controlling the operating system to display a swipe menu on a top edge of a display screen of a host computer; and
a bottom-edge swipe control command for controlling the operating system to display a swipe menu on a bottom edge of a display screen of a host computer.

19. The cursor control device as claimed in claim 12, wherein
the top cover has two touch areas; and
the detection unit has two sensing boards affixed on an inner top of the top cover and respectively corresponding to the two touch areas.

20. The cursor control device as claimed in claim 12, wherein the control unit has:
a touch controller electrically connected to the at least one sensing board to receive the position data of the finger gesture and identify the finger gesture as a swipe gesture; and
a main controller electrically connected to the touch controller and the cursor control module, and outputting the control command to the operating system according to the swipe gesture identified by the touch controller.

21. A method of using a cursor control device to launch a swipe menu comprising steps of:
detecting position data of a finger gesture on the cursor control device through a detection unit;
identifying the finger gesture as a swipe gesture according to the position data of the finger gesture; and
generating and outputting a corresponding control command to an operating system according to the swipe gesture for the operating system to display a corresponding swipe menu.

22. The method as claimed in claim 21, wherein the step of generating and outputting a corresponding control command further has steps of:
reading multiple pieces of position data corresponding to the finger gesture; and
determining if a displacement exists between a first one piece and any other piece of position data of the multiple pieces of position data, and if the displacement exists and the displacement is larger than a preset value, determining that the finger gesture is a swipe gesture.

23. The method as claimed in claim 21, wherein the step of generating and outputting a corresponding control command further has steps of:
defining a swipe zone on the touch control module;
reading multiple pieces of position data corresponding to the finger gesture.
determining if a first one piece of position data of the multiple pieces of position data falls on the swipe zone; and
if positive, further determining if a displacement exists between the first one piece of position data and any other piece of position data, and if the displacement exists and is greater than a preset value, determining that the finger gesture is a swipe gesture.

24. The method as claimed in claim 22, after the step of determining that the finger gesture is a swipe gesture, further comprising steps of:
comparing the multiple pieces of position data with each other to determine a moving direction of the swipe gesture; and
generating a corresponding control command according to the swipe gesture and the moving direction of the swipe gesture.

25. The method as claimed in claim 23, after the step of determining that the finger gesture is a swipe gesture, further comprising steps of:
comparing the multiple pieces of position data with each other to determine a moving direction of the swipe gesture; and
generating a corresponding control command according to the swipe gesture and the moving direction of the swipe gesture.

26. The method as claimed in claim 21, wherein the step of generating and outputting a corresponding control command further has steps of:
defining a swipe zone on the touch control module;
reading multiple pieces of position data corresponding to the finger gesture;
determining if any piece of position data falls on the swipe zone and if the piece of position data falling on the swipe zone is absent from the swipe zone after determining that the piece of position data falls on the swipe zone, and if positive, determining that the finger gesture is a swipe gesture; and
generating a corresponding control command according to the piece of position data falling on the swipe zone.

27. The method as claimed in claim 21, wherein the control command is further converted into a hot key signal of a swipe function supported by Win8™.
